(19) United States
(12) Patent Application Publication
(10) Pub. No.: US 2017/0132738 A1
(43) Pub. Date: May 11, 2017

(54) SEXUAL ACTIVITY CONSENT TRACKING

(71) Applicant: Safe Sex Consent Inc, Mooresville, NC (US)

(72) Inventor: Wendy Geller, Mooresville, NC (US)

(73) Assignee: Safe Sex Consent Inc., Mooresville, NC (US)

(21) Appl. No.: 14/934,562

(22) Filed: Nov. 6, 2015

(51) Int. Cl. G06Q 50/26; G06F 17/30

(52) U.S. Cl. CPC G06Q 50/265; G06F 17/30368; G06F 17/30882; G06F 17/30879

(57) ABSTRACT

A sexual activity consent recordation method is disclosed. A first individual and a second individual use at least one mobile device to respond to sexual activity inquires. Responses to the sexual activity inquiries are recorded and compared, and no matter whether they are compatible or non-compatible, an encounter record is transmitted to, and retained by, a third-party off-site database.

### FIELD OF THE INVENTION

The present invention relates to the field of permission retention and more specifically to the field of sexual activity precautions.

### BACKGROUND

There is a need for a solution to validating sexual activity consent that combines anonymity and security with simplicity to help sexual partners solidify their verbal consent to one another. Due to new legislation and the dual socio-economic crisis of high rates of sexually transmitted infections (1 in 2 sexually active people will get a STI between ages 15-25, at a cost of $16 Billion in the US according to CDC.gov 2015) and unplanned pregnancies (51% of US pregnancies are unintended yearly according to the American Journal of Public Health 2014, at a public expenditure of $21 Billion), before partners begin any sexual activity both will use the app, YES to SEX, to properly consent anonymously. This process allows users to document their sexual intent and protection chosen in a discreet manner.

The “Yes Means Yes” laws that have recently passed and recent case outcomes, require the sexually active public: especially students, to verify sexual consent verbally and/or in a written form. The passage of these laws and the outcome of multiple cases have brought to light the greater issue of proving conscious voluntary verbal consent when dealing with any issues of sexual misconduct. As federal legislation is introduced, e.g., the Fair Campus Act, Campus Safety Act and Title IX the issues of establishing these consensual facts will become amplified in scale and scope. Therefore, a unified method, an app that guides users to confirm their mental and physical states, their ages, their gender, their consent to sex and use of agreed protection, all anonymously, has been created through the present invention.

### SUMMARY

The present invention is directed to a method of validating sexual consent between sexual partners. The method issues to a first individual via a validation engine on a mobile computing device a first anonymized identification. Then a second individual is supplied via the validation engine an anonymized second identification. The validation engine displays predefined sexual inquiries to both the first individual and the second individual. These inquires are adapted to elicit an answer data set from both the first and second individual. An input consent statement and a recorded oral consent statement are captured from at least one of the first individual or second individual. A linked encounter record is transmitted from the validation engine to a WAN master retention database. The linked encounter record includes data elements from the first individual and second individual, including at least the first anonymized identification, the second anonymized identification, and the input consent statement and the oral consent statements.

The method may further utilize a first mobile computing device bearing the validation engine with the first anonymized identification, and a second mobile computing device also bearing the validation engine with the second anonymized identification. The validation ties the first mobile device and second mobile device into a discrete transaction. One or both mobile devices can send the linked encounter record to the WAN master retention database.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a view of the method of the present invention

FIG. 2 is a view of the method of the present invention

FIG. 3 is a view of the computer ecosystem of the present invention

FIG. 4 is a view of the computer ecosystem of the present invention

### DETAILED DESCRIPTION

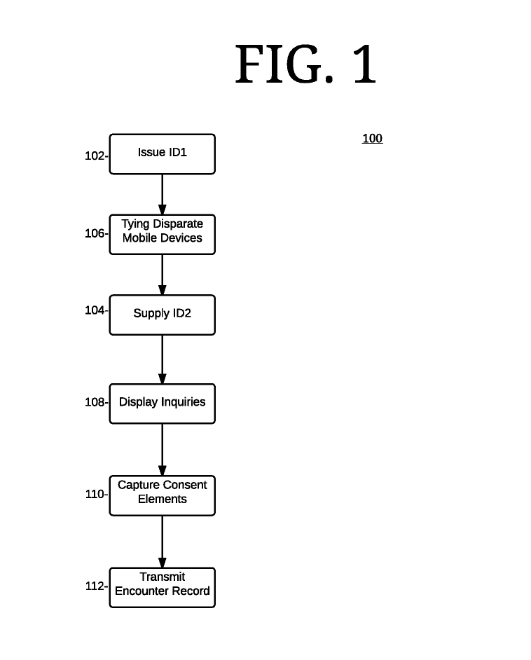

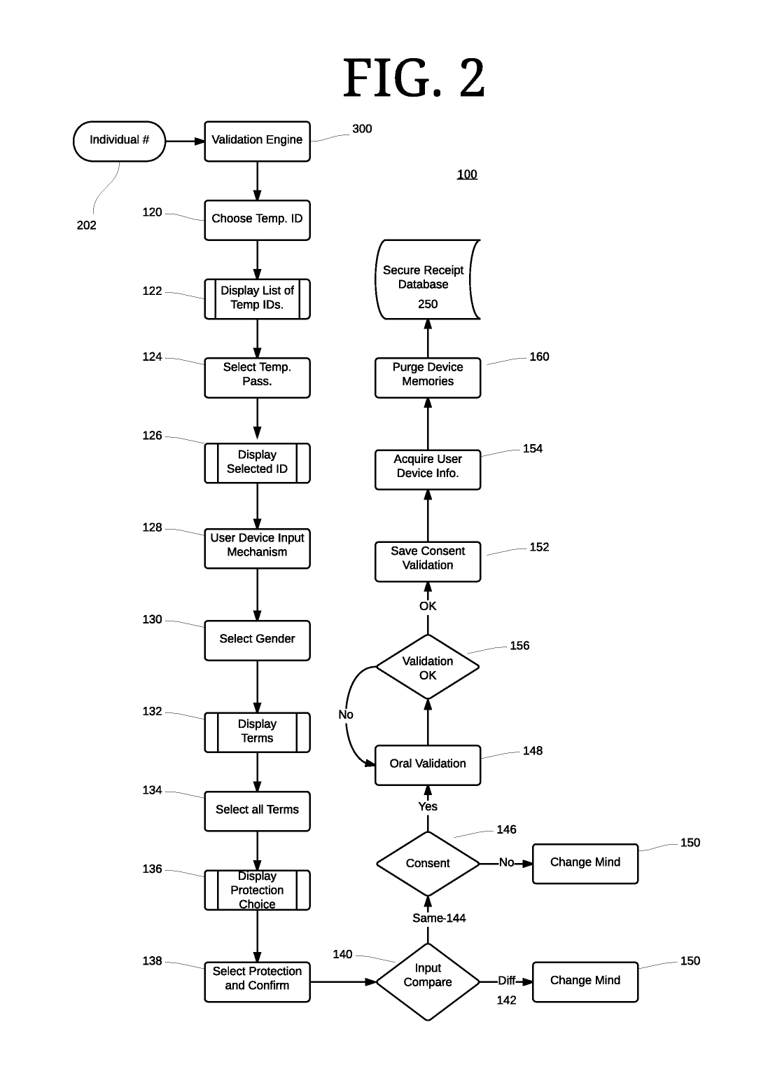

Referring first to FIGS. 1 and 2, a basic embodiment of tracking 100 sexual consent, and its underlying attributes, is shown. The preferred embodiment of the method is a computer software program in the form of a mobile device application with access to a wide area network (“WAN”), preferably the Internet. However, the WAN may include the network of a distributed college campus or other sizeable organization. The method relies on a means of storage other than that of a user's device for indefinite storage of certain data.

The software acts as a validation engine 300. By validation engine it is meant a series of repeatable, machine-readable instructions to an arithmetic logic unit. The validation engine preferably takes the form of a downloadable web application for use with a mobile device. The user may acquire the validation engine on a mobile device, such as a tablet, smart telephone, personal data assistant, or the like. The user may activate the validation engine when desired to memorialize consent to a sexual activity.

Upon activating the validation engine 300, a first individual is issued 102 an anonymized first identification. When the validation engine issues 102 the anonymized first identification, the user may select 120 the identification or the identification may be created and displayed 122 for the user automatically. It is preferred that the issuing step 102 be some mixture of automated issuance and selected 120 issuance; automation is preferred because the engine will not innately choose attributes for the individual, e.g. names, moods, hobbies, habitual nom-de-plumes, etc., and choice is preferred because it makes the identification more memorable. A preferred version of the engine asks a user to choose identification based on mood: “My mood at the moment is.” Users may then choose 120 from a list of multiple randomly generated identifications which may be a combination of mood and number. Under no circumstances will the identification be based on the actual name of an individual utilizing the validation engine.

The anonymized identification is formed by a combination of mood and number. The mood will be chosen from a mood list. Numbers will be auto-generated and will have multiple digits. But the randomly generated number for each user and session may be the same. A user may be provided with the following: “My mood at the moment is: Happy5567; Horny5567; Romantic5567; Angry5567; Sad5567; Neutra15567. Upon selection 124 of an identification, this identification is thereafter displayed 126 used to refer to the first individual within the engine session. The identification may change from session to session, or may be an identification tied to the user across many sessions. In certain versions of the present invention, the identification may be purely alphabet-character based (e.g., Happy) with the generation of a randomized number hidden from the user and used for purposes of device-device, or device-database, authentication and/or database constituent pairing.

The engine 300 may utilize one or more mobile devices for the method 100. The engine inquires as to the number of devices related to the transaction. If there are multiple mobile devices, then the engine ties 106 together the multiple devices into a single transaction by providing 128 a transaction synchronization token. The token may include any form of key that allows session constituents on separate devices to be tied together in a single transaction. The preferred form of session token is a session identifier that also includes any data elements acquired from the first device, aggregated into a graphic information means, e.g. QR code, that is then captured by a second mobile device without recourse to a WAN. The session token may include the number, or visual depiction thereof, generated in a prior step, e.g., the issuing step 102. Naturally, other forms of session synchronization may be used, including the creation of a session on a third-party network resource, touching phones or a point-to-point connection between mobile devices. Although a separate user may have the engine, downloaded under a separate license, for purposes of the present invention, there is only one validation engine because the output is tied into a single, linked record that goes to a single record storage location. Alternatively, the session may take place on a single mobile device. If the session takes place on a single device, and the process is shared, the steps of the present invention may occur sequentially for a single user prior to being passing to a second user, or the steps may occur alternatingly such that the users both, for example, answer a gender question prior to both answering a question regarding age. In either event, the engine displays 108 sexual activity inquiries to the first user.

The sexual inquiries of the present invention include attributes of the individual and the planned sexual activity. Users select each of the inquiries in order to confirm by providing an input consent statement. By input consent statement, it is meant that the user provide data related to the sexual activity. The data may be provided by free-form entry, by providing the user with a statement that the users confirms or supplies a short statement, or other. The data results in a written statement, or affirmation of a written statement into a data file. Example inquiries include: agreement 134 to terms of use of the engine as displayed 132 (including an intent to provide anonymous consent); age; physical/mental status (e.g., mental incapacitation, intoxication, etc.); the circumstances of the consent, e.g. voluntary or involuntary; confirmation 138 of method of sexual protection as displayed 136 (including, forms of birth control, sexually transmitted infection protection, etc.); and gender 130. Some of the sexual inquires may be yes/no or multiple choice or fill-in-the-blank or other inquiries. For example, it is preferred that questions related to birth control, list the forms of birth control. It is preferred that the inquiries be separated by screens so that assent and confirmation is acquired per inquiry. Among one or more of the inquiry screens may be displayed 150 a declination input. It is often the case that an individual interested in sexual activity may alter his/her opinion when forced to consider the ramifications of the sexual activity. As such, it is preferred that the declination input is a persistent sexual declination input. By persistent, it is meant that the input is available on more than one inquiry screen.

The inquiries may change based on the nature and location of the individuals, either in substance or quantity. The substance of the inquiries may change in cases where the location or nature affects the substance of fact at issue. For example, the ages of consent for sexual activity vary from state-to-state and country-to-country, so an inquiry may be stated as “Are at least [#] years of age?” wherein the variable ‘#’ is fetched from a data table correlating jurisdictions to ages of consent. The table may be in the memory of the mobile device or in storage available over WAN. Alterations to substance may be preferred in any situation in which a question is generally applicable, yet facts within the question is subject to variation, e.g. forms of birth control may be legal in certain jurisdictions but not others. Furthermore, some inquiries may not be relevant in certain jurisdictions, yet not in others. The geolocation may be determined by a manual input from the user, or by the characteristics of the mobile device of the individual. By characteristics it is meant the attributes of the mobile device, including its recognition of any handshake protocols or location-coding that indicate its geolocation.

At the conclusion of the sexual inquiry list, the most important of the sexual inquiries is posed: consent to sexual activity. The responses to the sexual inquiries may be buttressed by forms of supplemental answers. An example of buttressing 148 a sexual inquiry is a verbal consent to sexual activity. Preferred forms of sexual inquiry buttressing are biometric and other user-specific forms of responses, e.g. fingerprints, voice recognition, iris scanning, etc. The supplemental consent need not be topically related to sexual activity, particularly as the method should be capable of use in a public venue. It is preferred that the verbal consent be a phrase that includes either an affirmation or denial, but lacks any sexually explicit content. The consent may be: If you consent to sexual activity with Lucky1208, say “I'm saying YES! Our safe word is CODE AB”. Any verbal validation should be tested 156 for voice detection, which may include simplistically the existence of a verbal response, or in a more advanced state, clarity, to ensure that volume and background noise levels are appropriate. The responses to the sexual inquiries are captured 110 in an answer data set.

A second individual now accesses the validation engine, either through the original mobile device of the first individual or through a second mobile device, and is supplied 104 via the validation engine 300 an anonymized second identification in the same manner as the first individual. The second individual proceeds through the issuance of anonymized identification as discussed for the first individual, and then proceeds through the sexual inquiry display 108 and capture 110 process as discussed for the first individual.

The validation engine may then compare 140 the answer data set constituents of the first individual and the second individual. If there is a difference 142, then the validation engine can perform any number of actions. If the same 144, then the process 100 may continue. A preferred action for a difference can include an autodecline where the validation engine simply informs the users that the validation engine declines to further memorialize a consentual sexual activity response. The input comparison step 140 can occur at a conclusion of all entries for sequential entry versions of the present invention, or the input comparison step 140 may occur after both users have provided an input consent statement, e.g. 130 or 134 or 138, pursuant to an alternating version of the present invention that confirms statement-by-statement. A preferred action could alternatively include returning the first individual and/or second individual through some or all of the sexual inquiry display 108 and capture 110 process. During the comparison 140, the persistent autodecline input may be provided to these individuals. If the data set answers result in a match, then the validation engine considers consent 146 to be given.

Rather than providing the supplemental sexual inquiries in total prior to the consent 146 stage, supplemental sexual inquiries may be displayed subsequent to the consent 146 stage. As the preferred forms of supplemental sexual inquiries do not topically relate to sexual activity, these do not necessarily need to be captured prior to the consent. Instead, they can be captured subsequent to the consent as more of an evidentiary support means as opposed to a basis to substantively measure consent. The consent validation is saved 152 in a final form as a linked encounter record that serves as a receipt for the entire transaction between the individuals. This is a beneficial time to acquire user device information for the mobile device of the first individual and the second individual, especially geolocations; however, any mobile device characteristics of use during a contest of criminal, civil, or other serious allegations may be acquired. The linked encounter records include as many constituents of the individuals' responses as may be desired retained by an operator of the method 100.

The linked encounter record is then transmitted 112 from the validation engine to a WAN master retention database. The nature of the data captured by the present invention may lend itself to encryption, during the transmission process or perhaps even as early as the entry of responses into data sets. The WAN master retention database 250 is a means of off-site persistent storage that saves the linked encounter records for later retrieval in the event of an allegation of sexual assault, or other serious circumstance. It is further preferred that the mobile devices be purged 160 of any data related to any specific sexual activity transaction upon transmission of the linked encounter record.

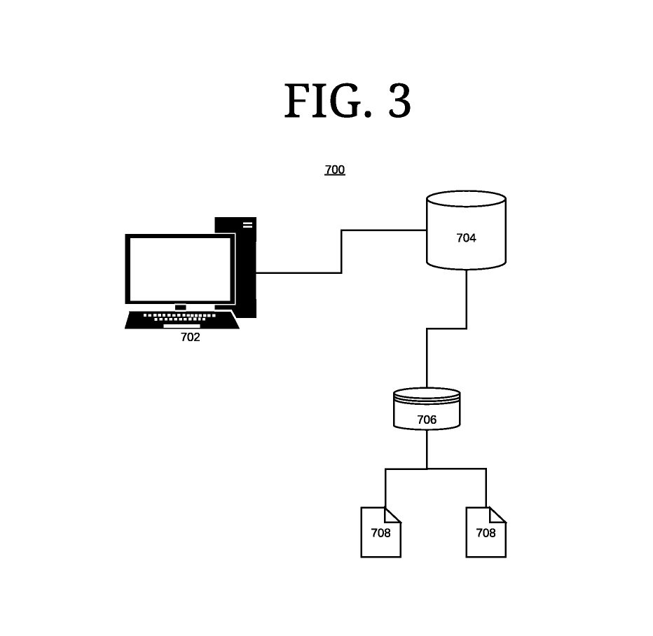

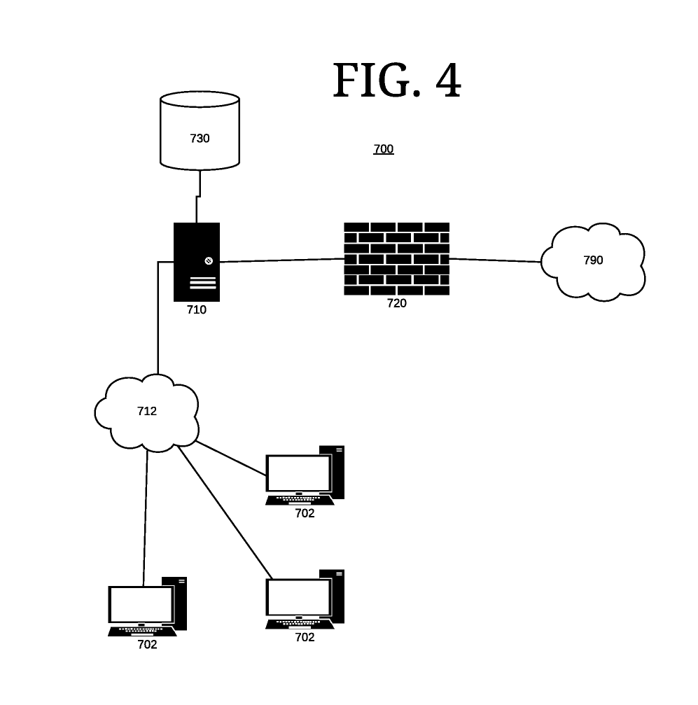

FIGS. 3-4 depict a computer ecosystem 700 of the present invention. By ecosystem it is meant one or more computers 702 that are organizationally related. The ecosystem may include computers under common ownership, computers that belong to the same network or series of networks, computers that are collaborating, etc. The present invention may be provided as a computer program product, or software that may include a computer-readable storage medium 704 having stored thereon instructions, which may be used to perform the process of the present invention across a computer ecosystem 700 according to the various embodiments disclosed herein.

A computer 702 of the present invention may include any combination of one or more computer readable media 704. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium 704 may be any tangible medium that can contain, or store a program for use by or in connection with an instruction execution system, apparatus, or device.

A computer readable signal medium 704 may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures described below illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Furthermore, the functionality of one block may be subsumed by the functionality of another block as a substep thereof. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

An ecosystem 700 may further include a computer network or data network that allows computers to exchange data. In a computer network of the present invention, networked computing devices pass data to each other along data connections. The connections between nodes are established using cable media, wireless media, or other media. The Internet or other exterior network 790 may be a component of the ecosystem 700. Nodes may include hosts such as personal computers, phones, servers, and networking hardware. Two such devices are networked together when one device is able to exchange information with the other device, whether or not they have a direct connection to each other. Computer networks of the present invention support applications such as access to the World Wide Web, shared use of application and storage servers, printers, and fax machines, and use of email and instant messaging applications. Computer networks may be included irrespective of the physical media used to transmit their signals, the communications protocols to organize network traffic, the network's size, topology, and organizational intent.

It is preferred that the network of the present invention have at least one boundary 720, and potentially multiple boundaries if a demilitarized zone is utilized. The boundary 720 may include any number of layers designed to regulate and secure the flow of information between networks. Boundary layers of the present invention may include enterprise content management software, firewalls, filters, threat management software, alarms, etc. Software for establishing a boundary may be run on a server 710 with server storage 730 of the present invention, which may include directory services controlling access credentials.

To combat security risks posed by network connections, firewalls are frequently used. A firewall may be a hardware or software component that filters network traffic so that communications with unauthorized third parties are blocked but legitimate network functions may be carried out. Frequently, the filters applied by a firewall are specified by a set of policies defining characteristics of network messages that either should pass through the firewall or that should be blocked. Because different levels of communication may be appropriate depending on the origin or destination of messages, firewall policies may be provided for each application that executes on a computing device and communicates over a network.

A firewall may have an outward side facing a global network, such as the Internet. The opposite side of the firewall may be a private network that is protected by the firewall. The private network may include any number of host machines (e.g., computers) each addressable by its own IP address. The physical construction of the network may be such that all data packets intended for one of the IP addresses behind the firewall pass through the firewall. Using the firewall rules, which may be set by a network administrator or other user, the firewall may determine whether to allow or deny certain data packets and/or determine where to route particular data packets based on the IP addresses to which the packets are directed. The determination of where to route data packets may be done using the IP addresses of the host machines in the private network.

Depending on the addressing scheme used by the network, the IP addresses of the host machines may be static or dynamic. Static IP addresses do not change over time, and thus once they are set in the firewall rules, there is no need to update them. The Internet Protocol version Four (IPv4) addressing system commonly uses static addressing, while IPv6 may use dynamic addressing. Dynamic IP addresses may change over time and thus, there is a need to update the firewall rules as changes occur. When a small Local Area Network (LAN), such as a domestic network in a private residence, is linked to a larger network such as the Internet, the link is often through a gateway router acting as a firewall. One of the functions of the firewall is to protect the LAN from intrusion from outside. A service directory accessible by a server 710, usually on server storage 730, stores information about network resources across a domain. An example of a directory service is Active Directory. The main purpose of Active Directory is to provide central authentication and authorization services for Windows-based computers. Active Directory also allows administrators to assign policies, deploy software, and apply critical updates to an organization. Active Directory stores information and settings in a central database.

An Active Directory structure is a hierarchical framework of objects. The objects fall into three broad categories: resources (e.g. printers), services (e.g. e-mail) and users (e.g., user accounts and groups). The Active Directory provides information on the objects, organizes the objects, controls access and sets security. Certain objects can also be containers of other objects. An object is uniquely identified by its name and has a set of attributes—the characteristics and information that the object can contain—defined by a schema, which also determines the kind of objects that can be stored in the Active Directory.

Typically, the highest object in the hierarchy is the domain. The domain can be further sub-divided into containers called Organizational Units. Organizational units give a semblance of structure to the organization either based on administrative structure or geographical structure. The organizational unit is the common level at which to apply group policies, which are Active Directory objects themselves called Group Policy Objects. Policies can also be applied to individual objects or attributes as well as at the site level (i.e., one or more IP subnets).

The present invention may use one of more communication networks to foster information exchange throughout the computers of the ecosystem. Communication networks might either be private or public. In a private network, communications between multiple computers occur in a secure environment that prevents access from outside the network without appropriate authentication. These networks are considered as “trusted” networks because the communication signals securely travel from one computer to another within the private network without being exposed to the external environment.

Public networks such as the Internet, on the other hand, are not secure because the communication over these networks is not private and is susceptible to interception by other computers. In addition, the public networks cannot guarantee the delivery of the data packets being sent. They allow packets to be injected into, or ejected out of, the networks indiscriminately, and analyzed while in transit. To keep data sent over a public network private, a Virtual Private Network (VPN) is commonly established on top of a public network when two computers use the public network to communicate with each other. In a Virtual Private Network, data sent from one computer to another is encrypted by a security gateway and transmitted in encrypted form over the public network to a second security gateway connected to the receiving computer. The second gateway decrypts the data before forwarding it to the receiving computer. Such a private channel established on top of another network is referred to as a network tunnel.

In order to set up a Virtual Private Network, a user first establishes a path to a VPN server and goes through an AAA process (Authentication, Authorization and Accounting) for identification and authorization to create a secure tunnel with the server. Once the user is authorized, a secure network tunnel is established between the user and the VPN server over the public network, using a VPN protocol such as IPsec. This process requires a VPN client on the user's side, a VPN server and other VPN hardware on the other side of the tunnel, as well as appropriate user configurations.

Today's private networks often include wireless networks such as WiMAX to accommodate mobile access. In addition, to provide mobility access in a large geographic area, a private enterprise often relies on third-party wireless infrastructures besides its own wireless network. In this case, a user's device would need to be authenticated by both a third-party gateway and an enterprise authentication server before it could access the enterprise network. User credentials are typically requested by and securely returned to the third-party gateway. Once the user is authenticated and authorized, the user may communicate with the third-party wireless gateway.

The present invention includes files 708, which may include executable instructions by which the present invention runs, or files upon and with which the present invention interacts. The documents may be on local storage 704 or shared storage 730 and be created, accessed, edited, and/or otherwise modified using any of a number of applications, including for example and without limitation Final Cut Pro, Avid, Microsoft Office applications (Word, Excel, Power Point, Outlook, Visio, etc.), Adobe Reader or Acrobat, AutoCAD, SolidWorks, or any other suitable document reading application. The content of the documents may be audio tracks, video clips, images, word processing documents, presentations, spreadsheets, business documents, engineering documents, databases, etc.

Although the present invention has been described in considerable detail with reference to certain preferred versions thereof, other versions would be readily apparent to those of ordinary skill in the art. It is significant to note that the present invention 100 may be performed in a preferred order, any order that results in an effective linked encounter record being transmitted to the master database may be allowed. Therefore, the spirit and scope of the appended claims should not be limited to the description of the preferred versions contained herein.

What is claimed is:

1. A method of validating sexual consent between sexual partners, comprising the steps of:
issuing to a first individual via a validation engine on a mobile computing device, having a non-transitory readable storage medium storing operational instruction for said validation engine, a first anonymized identification;
supplying to a second individual via said validation engine an anonymized second identification;
displaying via said validation engine predefined sexual inquiries to, and said inquiries adapted to elicit an answer data set from, both said first individual and said second individual;
capturing via said validation engine an input consent statement and a recorded oral consent statement from at least one of said first individual and said second individual;
transmitting from said validation engine to a WAN master retention database, having a non-transitory readable storage medium, a linked encounter record comprising: said first anonymized identification, said second anonymized identification, and said input consent statement and said oral consent statement.

2. The method of claim 1 further comprising the step of depicting via said validation engine a persistent declination input available to at least one of said first individual and said second individual during said displaying step.

3. The method of claim 2 further comprising the step of comparing via said validation engine said first individual data set to said second individual data set and generating an individual alert based thereon to at least one of said first individual and said second individual.

4. The method of claim 3 wherein said comparing step generates via said validation engine an autodecline based on said comparison based on a data set difference.

5. The method of claim 1 wherein said displaying step includes inquiries are substantively dependent on a geolocation.

6. The method of claim 1 further comprising the step of acquiring via said validation engine characteristics of said mobile device.

7. The method of claim 6 wherein said displaying step includes inquiries are substantively dependent on said mobile device characteristics.

8. The method of claim 6 wherein said transmitting step includes transmitting from said validation engine to said WAN master retention database said linked encounter record comprising said mobile device characteristics.

9. The method of claim 1 wherein said oral consent lacks topical relation to a sexual activity.

10. The method of claim 1 wherein said issuing step and supplying step include anonymized identification with a session specific user-selected portion and a session specific device-generated portion.

11. The method of claim 1 further comprising the step of purging said non-transitory readable storage medium of said linked encounter record

12. A method of validating sexual consent between sexual partners, comprising the steps of:
issuing to a first individual via a validation engine on a first mobile computing device, having a non-transitory readable storage medium storing operational instruction for said validation engine, a first anonymized identification;
supplying to a second individual via said validation engine on a second mobile computing device, having a non-transitory readable storage medium storing operational instruction for said validation engine, an anonymized second identification;
tying into a discrete transaction said first mobile device to said second mobile computing device, having a non-transitory readable storage medium storing operational instruction for said validation engine;
displaying via said validation engine predefined sexual inquiries to, and said inquiries adapted to elicit an answer data set from, both said first individual on said first mobile computing device and said second individual on said second mobile computing device;
capturing via said validation engine an input consent statement and a recorded oral consent statement from at least one of said first individual and said second individual; and
transmitting from said validation engine to a WAN master retention database, having a non-transitory readable storage medium, a linked encounter record comprising: said first anonymized identification, said second anonymized identification, and said input consent statement and said oral consent statement.

13. The method of claim 12 wherein said tying step includes tying into a closed network consisting of said first mobile device and said second mobile computing device for said discrete transaction.

14. The method of claim 13 wherein said tying step includes initiating said closed network via GUI interface transfer.

15. The method of claim 14 wherein said tying step includes initiating said closed network via GUI interface transfer comprising a 2-Dimensional visual code.

16. The method of claim 13 wherein said transmitting step includes transmitting from said validation engine on both said first mobile computing device and said second mobile computing device to said WAN master retention database said linked encounter record.

17. The method of claim 1 further comprising the step of purging said non-transitory readable storage medium of said first mobile computing device said linked encounter record constituents of said second mobile computing device, and purging said non-transitory readable storage medium of said second mobile computing device said linked encounter record constituents of said first mobile computing device.

18. The method of claim 12 further comprising the step of depicting via said validation engine a persistent declination input available to at least one of said first individual and said second individual during said displaying step.

19. The method of claim 12 further comprising the step of comparing via said validation engine said first individual data set to said second individual data set and generating an individual alert based thereon to at least one of said first individual and said second individual.

20. The method of claim 12 wherein said comparing step generates via said validation engine an autodecline based on said comparison based on a data set difference.
